(19) United States
(12) Patent Application Publication
(10) Pub. No.: US 2003/0016725 A1
(43) Pub. Date: Jan. 23, 2003

(54) Thermocouple device

(76) Inventors: John Whateley, Whitchurch (GB); Gareth Bray, Whitchurch (GB); Brian Marshall, Whitchurch (GB)

Correspondence Address: Amersham Biosciences Corp, 800 Centennial Avenue, Piscataway, NJ, 08855, US

(21) Appl. No.: 10/197,110

(22) Filed: Jul. 17, 2002

(30) Foreign Application Priority Data
Jul. 17, 2001 (GB) 0117376.4

(51) Int. Cl. G01K 17/00

(52) U.S. Cl. 374/31

(57) ABSTRACT

A device for measuring small temperature changes comprises a calorimeter containing a sample chamber for containing a sample, a detector means, such as a thermocouple, thermopile or thermistor or the like, for producing an output signal relating to changes in temperature and a preamplifier for amplifying said output signal.

### FIELD OF THE INVENTION

The present invention relates to thermistor devices and methods for measuring heat using said devices.

### PRIOR ART

Thermistors are devices used to measure temperatures. A thermistor is a semiconductor component that exhibits large changes in resistance with temperature. Typically the changes of resistance are of the order of several hundred ohms per degree Centigrade with a nominal resistance of, for example, 100,000 Ohms at 25° C. Measuring the change of resistance of a thermistor therefore gives a measure of a change of temperature of the thermistor.

Detectors such as thermistors are often used to measure changes of temperatures that occur in calorimeters. In microcalorimetry, respectively nanocalorimetry, small quantities of chemicals are reacted in a sample holder in a calorimeter and heat energy in the order of microcalories, resp. nanocalories, is emitted or absorbed. The resulting temperature changes can be measured by measuring the change in the resistance of a thermistor. Normally the signals from the thermistors are amplified before being measured.

In prior art microcalorimetry and nanocalorimetry devices the thermistor is attached to, or inserted into, the sample holder and thus measures the temperature change of the reagents, sample holder and itself. A problem is that the quantity of heat energy liberated or absorbed in a reaction is very small and the resulting change of temperature is equally small. Thermistors also warm up during use and this self-heating adds to the temperature changes experienced by the thermistors. This means that the signal is often difficult to detect as it can be submerged in background noise picked up on the wires leading to the amplifier and the self-heating of the thermistors. A method of reducing this noise is to enclose the calorimeter, wires and amplifier by a Faraday cage. This however is undesirable as it restricts assess to the calorimeter and increases the costs of the apparatus. Methods of reducing the effects of self-heating can include using a compensating signal from reference thermistors that is similar to the measuring thermistor and which is assumed to have the same self-heating effect as the measuring thermistor to compensate for the self-heating.

### SUMMARY OF THE INVENTION

According to the present invention, at least some of the problems with the prior art are solved by means of a device having the features present in the characterising part of claim 1 and a method having the features mentioned in the characterising part of claim.

### BRIEF DESCRIPTION OF THE FIGURES

FIG. 1 shows schematically a first embodiment of a device for measuring small temperature changes in accordance with the present invention.

FIG. 2 shows an example of a circuit suitable for use with the device of FIG. 1.

FIG. 3 shows schematically a second embodiment of a device for measuring small temperature changes in accordance with the present invention.

### DETAILED DESCRIPTION OF EMBODIMENTS ILLUSTRATING THE INVENTION

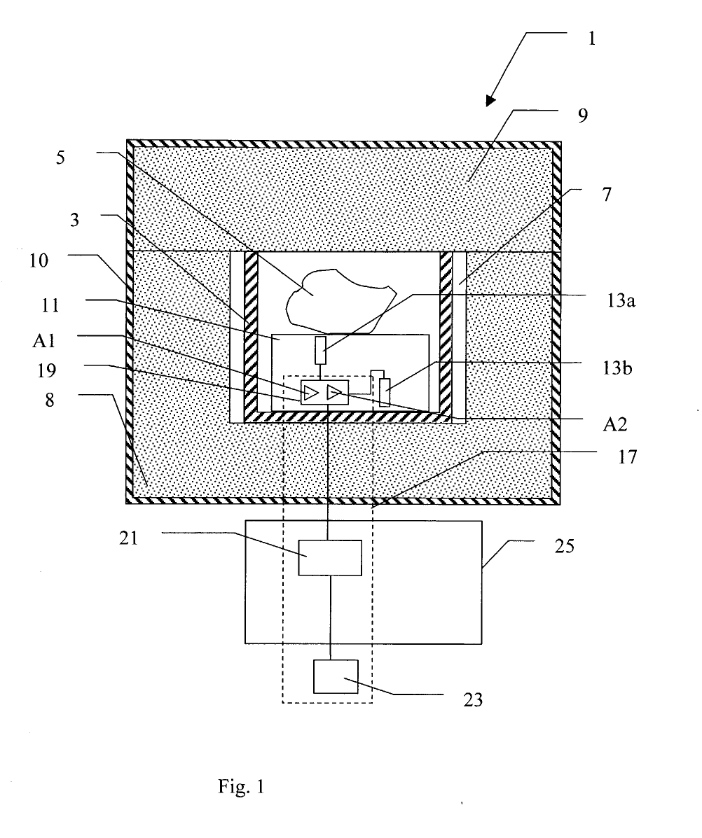

FIG. 1 shows schematically a first embodiment of a device 1 in accordance with the present invention for measuring small temperature changes. Device 1 comprises a sample holder 3 that is intend to contain a sample 5, the temperature changes of which are to be measured. Sample holder 3 is positioned inside a chamber 7 in an insulated calorimeter 8. Chamber 7 is provided with an access port, for example a removable lid 9, in order to allow access to the chamber 7. Sample holder 3 is provided with detector means 11 for producing an output signal Sₒᵤₜ in response to changes in its temperature. In this embodiment detector means 11 comprises a plurality of thermistors 13a, 13b, arranged in a thermistor bridge, with one thermistor 13a being used as a sensing thermistor to register temperature changes while another thermistor 13b is used as a reference thermistor in order to establish a reference signal. The thermistors are preferably of the R-T curve matched type. The thermistors 13a-13b are connected to an amplifier circuit 17 shown enclosed by dashed lines in FIG. 1. The amplifier circuit 17 is built in two parts, a pre-amplifier 19, local to the sensing thermistor 13a, is mounted in said calorimeter chamber 7. The other part of the amplifier circuit 17 comprises a power amplifier 21, and power supply components 23, these are preferably arrange remotely, for example in or near a remotely positioned control unit 25.

The preamplifier 19 preferably utilises op-amps, e.g. LT1051 op-amps A1, A2, because of their low noise characteristics and their extremely low input offset voltage of 5.0 10⁻⁴ mV. In this embodiment, the amplifier circuit 17 operates from a 12V switched mode power supply 23, located externally to the preamplifier 19, in order to reduce induced noise and make power supply filtering easier. The circuit consumes approximately 6 mA. Thus, the measuring current is designed to be very small, and preferably, the time that it is applied is also very small as the current to each thermistor may be switched off between measurements. Consequently the thermistors are only intermittently on and the self-heating effects are reduced. The exterior 10 of calorimeter 8 or sample chamber 3 is preferably made of metal in order to act as a Faraday cage.

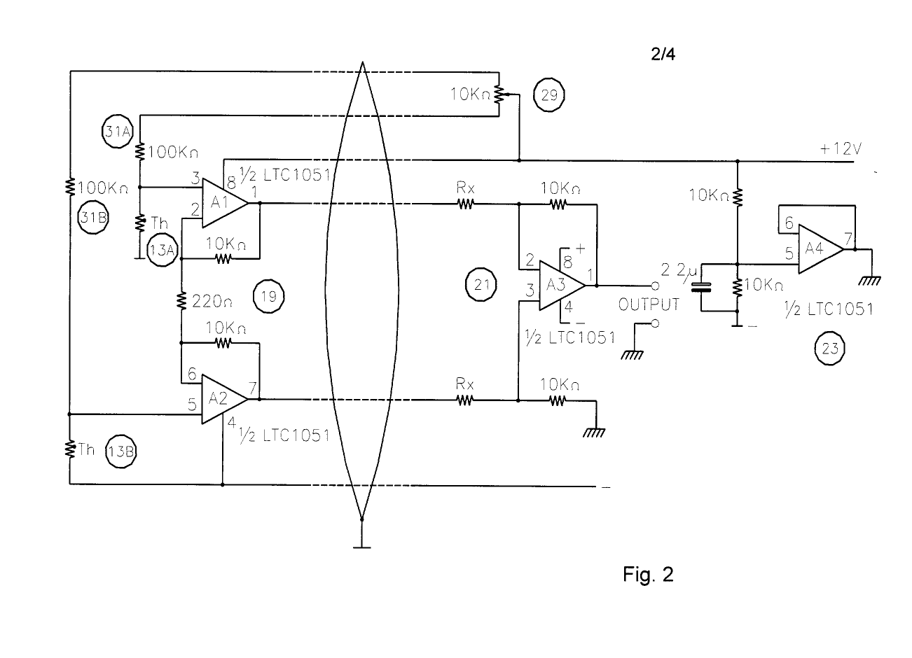

FIG. 2 shows a circuit diagram for the amplifier circuit for use with the device of FIG. 1. The thermistors 13a-13b can be fed from the 12V supply 23 via a 10KΩ balancing potentiometer 29 and their respective 100kΩ loads 31a, 31b. The balance potentiometer 29 may be mounted in the remotely positioned control unit 25 in order to set a balance point against imbalances in component values.

The output signal Sₒᵤₜ from the thermistor bridge 15 can be fed to an instrumentation amplifier consisting of opamps A1, A2 and A3, this type of amplifier being preferred due to its outstanding common mode rejection ratio. A1 and A2 give nominal gains of 100 (91.9 actual) and their outputs can be fed to the remote panel where they are combined in A3. At this point, any noise induced in the connecting cable will be equal and opposite in the two anti-phase signals and this noise will therefore be cancelled out at the inputs of A3. The gain can be set by the 10 KΩ feedback resistors and Rx. If Rx is chosen to be 100 Ω then this will give a further 100 times gain (101 actual), but it may be difficult to balance the system. In a preferred embodiment of the present invention, a set of gain switching resistors with values of 100Ω, 1kΩ, and 10KΩ may be incorporated, giving total gains for this stage of 100, 10 and 1 respectively.

Op-amp A4 can be used as a power supply splitter, the two 10KΩ resistors being stabilised by the 2.2ΩF. capacitor and buffered by A4, and this provides a half-supply reference for the input and output of A3. The output of the system swings plus and minus 6V with respect to this reference.

The overall system gain is a theoretical maximum of 9201.1, which gives a maximum sensitivity of plus and minus 3.7 10⁻³° C.

Preferably the preamplifier and detector means, i.e. the thermistors, are built directly onto or into a chip. The chip can be made of any suitable material such as semiconducting materials, e.g. silicon, or insulating materials such as plastics, e.g, Nylon, PTFE, etc. This provides significant advantages such as increased mechanical strength with associated ease of handling and reduced volume with associated reduce heat capacity. Using null offset devices means that the addition of amplifiers onto the chip does not introduce problems with noise.

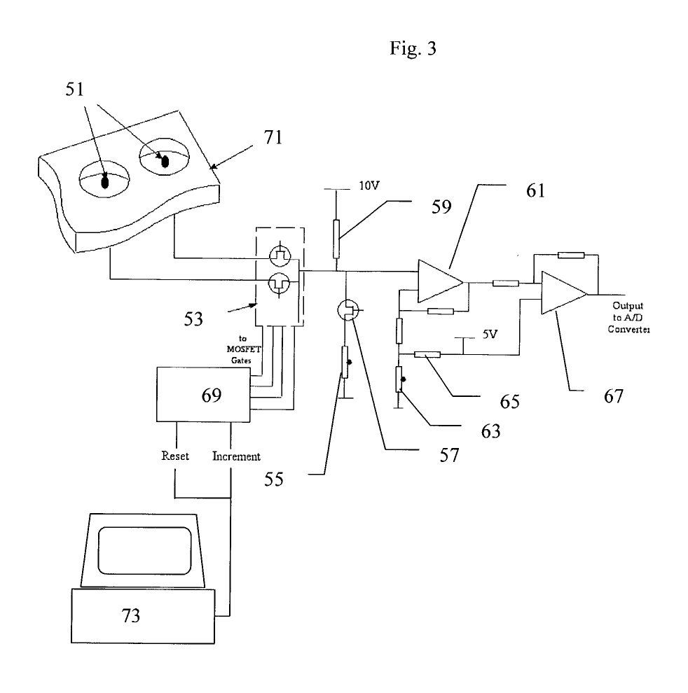

An example of an embodiment of the present invention comprising an array of wells each containing a thermistor is shown schematically in FIG. 3, here the reference numerals refer to the following features:

51—R-T curve matched thermistors in wells

53—Array of switching MOSFETs with low RDSₒₙ.

55—Reference thermistor 1

57—Reference thermistor MOSFET

59—Load resistor

61—First op-amp

63—Reference thermistor 2

65—Bias resistor

67—Second op-amp

69—Counter/Decoder

71—96-well array

73—computer

The circuitry shown in FIG. 3 is a diagrammatic representation of a highly sensitive multi-well calorimeter capable of discerning temperature changes of less than 3.7×10⁻⁴ degrees Centigrade. FIG. 3 shows part of a 96 well array 71 with R-T curve matched thermistors 51 fitted in the bottom of each well. The thermistors 51 are in series with switching MOSFETs 53 and load 59. A reference thermistor 55, preferably mounted on a printed circuit board, with it's own MOSFET 57 is also connected across this circuit.

Signals from a Counter/Decoder 69 switch the MOSFET gates thus placing each thermistor 53 into circuit as required.

Reset and increment signals are fed from a computer 73 into the counter/decoder 69 under software control. A Reset input from the computer 73 forces the Counter/decoder 69 to select MOSFET 57, which switches into the circuit, thermistor 55, a reference thermistor.

This reference thermistor 55 is used to reduce the step in amplitude when compared to the measuring thermistors 51.

The increment signal steps the output sequentially from well to well. The output from the potential divider made up of load 59 and the relevant thermistor/MOSFET combination, feed into op-amp 61.

Op-amp 61 is used to amplify the signal from the thermistor network and to provide temperature compensation. It is measuring such a small temperature change, the total range of the output represents only a small fraction of a degree, therefore, if the ambient temperature changes, it is likely to saturate the output in one direction or the other. Thermistor 63 and its bias resistor 65, compensate for any small change in ambient temperature.

Op-amp 67 is used to invert the signal, so that the output is positive going as the temperature rises. Op-amp 67 is also used to further amplify the signal and to reference it to half the supply rail, in order to read both positive going and negative going trends.

Thermistors suffer from self-heating effects. In order to measure the resistance of a thermistor, a current must be passed through it and a measurement taken, either of the current through it, or the voltage across it. In this circuit the measuring current is designed to be very small, and the time that it is applied is also very small as the current to each thermistor is switched off between measurements. Thus the thermistor is only intermittently on and the self-heating effects are reduced. The software of the present invention takes a reading at approx. 1 millisecond per well, just enough time for the op-amps to settle, and a reading to be taken. The software allows readings to be taken at regular intervals from 10 per second upwards. The combination of scanning and the low reference current result in a self heating effect of less than 1×10⁻⁸ degrees with a resultant time constant of several seconds, which has negligible effect on the reading taken.

The electronics shown in FIG. 3 are preferably enclosed in a brass enclosure (not shown), which has temperature controlled water passing through it for temperature stabilisation. This enclosure acts as a Faraday cage to reduce susceptibility to noise.

It is conceivable to also incorporate the A/D converter into the enclosure, and use a timebase to control the timing more accurately; signals would then be sent from this unit to a computer.

A data acquisition system suitable for use with this embodiment has the following software specifications:

The system should have the ability to:

1: acquire data from the 96 channels of the multiplexer unit 100 times a second

2: signal levels +/−5V at an resolution of about 1 mV

3: produce a graph showing the signal level against time

4: save the data into suitable format, e.g. an ASCII text file, that can be read by another program (e.g. Microsoft Excel™)

Hardware suitable for use in the present invention would be a personal computer equipped with a National Instruments PCI-6035E Multi-IO data acquisition card (16 bit Analogue input resolution—for 10V bipolar operation this corresponds to 0.3 mV)

National Instruments SCB-68 Shielded Connector Block

National Instruments SH68-68-EP Shielded cable

Software suitable for achieving the present invention would be:

13Software Development Tools

Windows 2000 Professional

Borland Delphi

National Instruments NI-DAQ software

National Instruments Measurement and

TeeMach TChart 4.0 Pro0

Connection Details

Multiplexer Signals

Output: The multiplexer unit produces a stepped analogue output

Inputs: Requires two digital control inputs, one to reset the multiplexer to channel 0, and the other to advance through the multiplexer channels.

Using the SCB-68 connector block and the shielded cable, the multiplexer output is connected into analogue input channel 0 in differential mode on the 6035E card. The digital control signals are connected to the digital I/O lines DIO0 and DIO1 for channel advance and multiplexer reset respectively.

Program Details

A software program for the present invention could be as follows: the program may be written in Delphi and first configures the 6035E data acquisition card for using the digital I/O lines as output, and then resets the multiplexer to channel 0. The program then waits for the user to input the number of data points they wish to collect and the time interval between them. The program may collect an additional data point so that the user has a reading at time zero. When the start button is clicked the program allocates memory for the storage of the data to be collected, clears the graph of the current results, and starts the timer that will perform the measurements.

At every timer interval the program resets the multiplexer, executes a short delay to allow the data to stabilise, and then performs an analogue I/O to get the data for channel 0, steps to the next multiplexer channel, executes the delay, reads channel 1, steps to the next multiplexer channel, executes the delay, reads channel 2, etc. until all 96 channels have been read.

The data is then stored in the internal memory buffer that was allocated at the start of the run.

The graph of the results is updated, regularly, e.g. every 500 ms, or longer if the data acquisition period is greater than this.

At the end of the run the data is stored to disk, either in the directory that the program is in, or in the location chosen in ‘File −>Set directory . . . ’.

Data manipulation may be included in the software, allowing, for example, differentiating the signals, and to integrate the areas under the curves.

The data collection rate may be increased beyond 100 Hz, and in order to maintain this collection rate while the results are being graphed, and to allow a larger number of data points to be collected at this faster rate it is conceivable to use the data acquisition card's own timers as the source of the signals for resetting the multiplexer and advancing the channel count, and to make the card perform DMA based data acquisition. The card is theoretically capable of performing 200,000 AD conversions a second, which should allow a data point collection rate of up to 12500 Hz (˜0.1 ms) although at this rate the multiplexer may conveniently be replaced with a sample and hold unit in order to get the signals properly synchronised with each other.

It is also possible to provide an array of detector means each with its own pre-amp on a chip. The power amplifiers do not need be intimately associated with the sensor and, as described above, may reside in a separate location. By using relatively fast switching the signal from n sensors may be addressed by a subset of power amplifiers. Thus, for example, every ten sensors might only need one power amp which can switch between them in a programmed manner.

Devices in accordance with the present invention are particularly suitable for measuring biological or biochemical reactions in which very small quantities of heat are emitted or absorbed and the temperature changes are small.

The above mentioned embodiments are intended to illustrate the present invention and are not intended to limit the scope of protection claimed by the following claims.

What is claimed is:

1. A device for measuring small temperature changes comprising a calorimeter containing a sample chamber for containing a sample, a detector means for producing an output signal relating to changes in temperature wherein said detector means is operated intermittently when measuring temperature changes.

2. The device of claim 1, wherein said calorimeter further comprises a preamplifier for amplifying said output signal and said preamplifier is contained in said sample chamber.

3. The device of claim 1, wherein said sample chamber is surrounded by a Faraday cage.

4. The device of claim 1, wherein said sample chamber, preamplifier and detector are integrally formed on or in a chip.

5. The device of claim 1, wherein said preamplifier and detector are integrally formed on or in a chip.

6. The device of claim 4, wherein said chip is made of silicon or plastic.

7. The device of claim 1, wherein said device comprises a plurality of sample chambers.

8. The device of claim 7, wherein each sample chamber includes a detector and preamplifier.

9. The device of claim 7, wherein the outputs from said preamplifiers are connected to a single power amplifier.

10. A calorimeter array comprising two or more sample-receiving wells on a substrate, wherein each well contains a thermistor for sensing temperature changes in said well.

11. The calorimeter array of claim 10 further comprising means for pulsing said thermistors on and off.

12. The calorimeter array of claim 10 further comprising multiplexing means for multiplexing signals from said thermistors.

13. The device of claim 1, wherein said means for detecting temperature change is a thermistor.

14. The device of claim 5, wherein said chip is made of silicon or plastic.
